(19) United States
(12) Patent Application Publication
(10) Pub. No.: US 2002/0125004 A1
(43) Pub. Date: Sep. 12, 2002

(54) Micro-multiport tubing and method for making said tubing

(76) Inventor: Frank F. Kraft, Adrian, MI (US)

Correspondence Address: Harness, Dickey & Pierce, P.L.C., P. O. Box 828, Bloomfield Hills, MI, 48303, US

(21) Appl. No.: 09/758,743

(22) Filed: Jan. 11, 2001

(51) Int. Cl. F16L 9/18; F16L 11/00

(52) U.S. Cl. 165/180; 138/115; 165/905

(57) ABSTRACT

This invention is a process for making improved micro-multiport tubing for use in heat exchangers. A multivoid heat exchanger tube is extruded from aluminum alloy billet. The alloy is a composition of cooperative elements which act with the aluminum to prevent recrystallization and grain growth which result in the necessary strength and duality of characteristics in the tubes. The composition of the alloy that is added to aluminum is some or all of the following: silicon, iron, copper, magnesium, manganese, zinc and titanium. The cold work during processing of the heat exchanger is limited to further retain the small grains.

### BACKGROUND AND SUMMARY OF INVENTION

Contemporary automotive air conditioning systems typically use parallel flow condensers, other heat exchangers, and gas coolers which are used on CO₂ systems that are fabricated with extruded tubing. This tubing, which is referred to as micro-multiport (MMP) tubing, is made from 1XXX or 3XXX Al alloys. The tubing is a flat body with a row of side-by-side passageways, which are separated by upright webs. Processing of this tubing involves extrusion, a straightening, sizing and cutting operation, assembly and furnace brazing. Brazing is generally done at 600°-605° C. (about 94% of the melting temperature of pure Al). The tube straightening and sizing operation imposes a small amount of cold work, in the critical range, which causes extremely coarse grains to grow during the brazing process.

Material handling involves winding the tube on coils and transferring these coils to a straightening and cutting operation. It is during this operation that the final width, thickness and length dimensions of the cut pieces are achieved. The cut pieces are then assembled into a condenser core with fin stock and headers that are clad with a brazing alloy. This assembly is brazed at 600 to 605° C.

The production of automotive condensers from aluminum MMP tubing involves an interaction of the tubings and process conditions that can result in undesirable material properties. The combination of a small amount of cold work and the high brazing temperature that must be imposed on the tube cause extremely large grains to form, and this has a significant effect on mechanical properties.

Small amounts of cold work are imposed on the tube during straightening/sizing and material handling. This small amount of deformation can lead to a phenomenon in which very large grains in the aluminum are formed during the brazing process. If a critical amount of cold work is imposed on the tube prior to brazing, then extremely large grains will form after recrystallization. The critical amount of cold work is defined as the amount of strain just necessary to initiate recrystallization. Since few nuclei are formed in the metal, the growth of relatively few recrystallized grains are allowed to proceed with minimum resistance. Conversely, as the amount of cold work increases, more nuclei are produced and the recrystallized grain size decreases.

This invention improves the grain size and the metallurgical strength of the tube by limiting cold working the tubes and thereby controlling the grain size. A multivoid heat exchanger tube is extruded from aluminum alloy billet. The alloy is a composition of cooperative elements which act with the aluminum to prevent recrystallization and grain growth which result in the necessary strength and duality of characteristics in the tubes. The composition of the alloy that is added to aluminum is some or all of the following: silicon, iron, copper, magnesium, manganese , zinc and titanium.

The cold work that is imposed on the tube during the winding, unwinding, straightening and sizing operations varies and is unevenly distributed within the tube. Controlled amounts of cold work imposed during the straightening/sizing operation typically range from 4 to 7%. Metallurgically, this cold work is the driving force for very large grains to form during the thermal cycle of the brazing process. The grains that develop can grow to over 1 mm in size. The large grain size results in a decrease in strength, a decrease in ductility, and it may influence the corrosion properties of the tube in the brazed heat exchanger.

The dimensions of the tube can range in width (4 mm to 50 mm), in thickness (1 mm to 5 mm), and in both internal and external wall thickness (0.15 mm to 1 mm). The number of internal walls typically range from 5 to 20.

Much of the cold work is distributed in the internal walls of the tubing during processing, and it is here that the large grains nucleate during the brazing process and ultimately envelop the entire tube. By limiting the cold work during processing, primarily during the straightening and sizing operations, in addition to using an aluminum alloy with distinct element additions, the grain size of the tube in the brazed component can be controlled by preventing recrystallization and grain growth from occurring.

Note that a certain amount of cold work (a critical amount) is required for the nucleation of new grains during a thermal cycle, and specific alloying additions serve to increase this level of cold work. The result will be that the tube in the brazed condition will have a higher yield strength, tensile strength, burst strength, elongation, and improved creep and fatigue properties. Corrosion properties may also likely be improved.

Further objects, features and advantages will become apparent from a consideration of the following description and the appended claims when taken in connection with the accompanying drawings.

### BRIEF DESCRIPTION OF THE DRAWINGS

FIG. 1 shows a heat exchanger utilizing the multiport tubing of this invention;

FIG. 2 is an enlarged cross-sectional view of the tubing of this invention as seen from the line 2-2 in FIG. 1; and

FIG. 3 is a fragmentary cross-sectional view of the tubing shown in FIG. 2, in the form before the tubing was subjected to cold working.

### DETAILED DESCRIPTION OF THE PREFERRED EMBODIMENT OF THE INVENTION

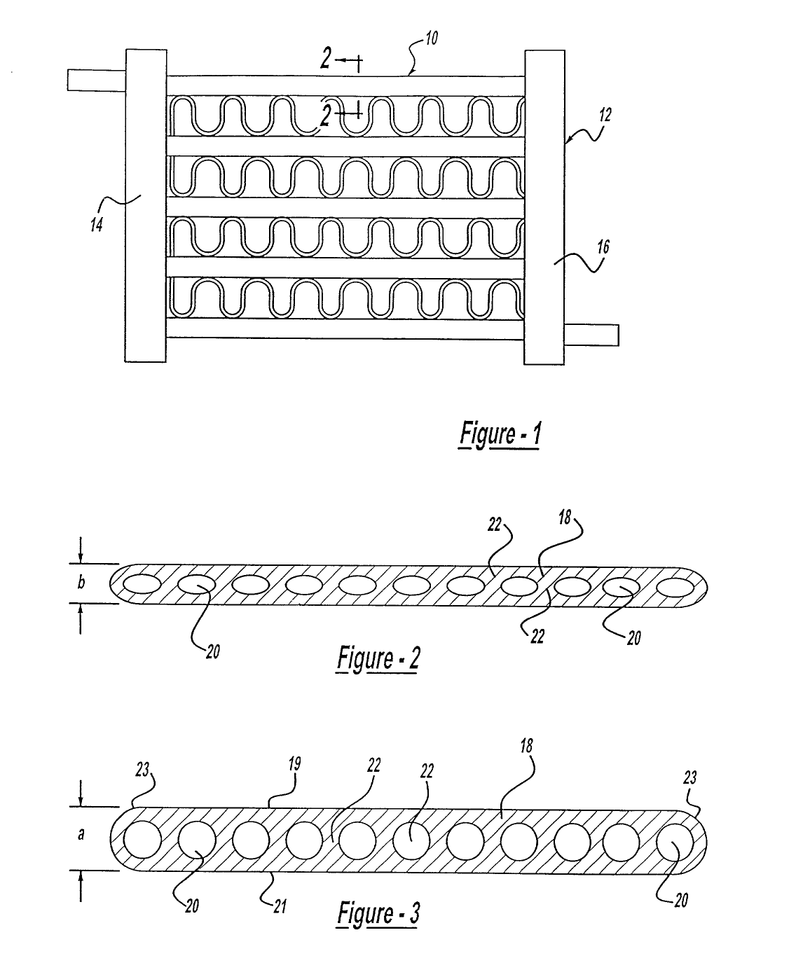

With reference to the drawing, the tubing of this invention, indicated at 10 in FIG. 1, is shown in a heat exchanger 12 with frame members 14 and 16. The tubing 10 consists of a metal body 18, which is an aluminum alloy. The body 18 is made by extrusion and the shape of the extruded body 18 is as shown in FIG. 3. The body is generally rectangular in shape having opposite faces 19 and 21 and outwardly facing rounded edges 23. A number of ports or passages 20 are arranged side-by-side between the edges 23. All of the ports 20 are of the same size and shape except for the end ports which vary only on one side.

As shown in FIG. 3, the ports 20 are defined by internal walls or webs 22, which extend in upright positions with a reduced thickness section 24 in substantially the center of the web 22. In the body 18 illustrated in FIG. 2, there are eleven ports 20 (10 webs) in side-by-side relation and each one is defined by at least one web 22. The tube 18 is of a flattened configuration having a width that is at least three times as long as the height “a” of the body 18. In actual practice, the body 18 can be 6 mm to 50 mm wide, 1mm to 2 mm inches high and part of a long extrusion, which is coiled for subsequent cutting into strips and straightening.

It is during the coiling, straightening and cutting operations that the final width, thickness “b” and length dimensions of the cut pieces are achieved. These pieces are then assembled into the frame 12 and subjected to brazing with a brazing alloy at temperatures between 600° and 605° C. In this invention, the body 18 is subjected to rolling in order to straighten the tube in this plane and achieve the final thickness dimension “b”. A minimal amount of cold working of the body 18 functions to control the grain size of the metal. In other words, the smaller grains of the extruded tube are retained since the critical amount of cold work for this alloy is not exceeded.

Much of the cold work is distributed in the internal walls of the tubing during processing, and it is here that the large grains nucleate during the brazing process and ultimately envelop the entire tube. By limiting the cold work during processing, primarily during the straightening and sizing operations, in addition to using an aluminum alloy with distinct element additions, the grain size of the tube in the brazed component can be controlled by preventing recrystallization and grain growth from occurring.

The composition of the alloy is a combination of elements taken from the following chart in the amounts stated as follows:

| | Si | Fe | Cu | Mn | Mg | Zn | Ti | Each | Total | Al |
|---|---|---|---|---|---|---|---|---|---|---|
| Minimum | 0.15 | | 0.006 | 0.70 | | | | | | |
| Maximum | 0.60 | 0.70 | 0.70 | 1.70 | 0.30 | 0.20 | 0.05 | 0.05 | 0.10 | remainder |

Accordingly, this invention provides an improved process for enhancing the metallurgical strength of a multivoid tube for use in a heat exchanger. The cold work on the tubes is limited to reducing 5% of the thickness of the tubing. The preferred alloy is:

Alloy with

minimum 0.20% Si

minimum 0.50% Fe

minimum 0.05% Cu

minimum 1.00% Mn

remainder Al

From the above description, it is seen that this invention enhances the metallurgical strength of the tubing 10 so that the life of the heat exchanger 12 is extended and the tubing 10 will function for a longer time without maintenance.

The foregoing discussion discloses and describes a preferred embodiment of the invention. One skilled in the art will readily recognize from such discussion, and from the accompanying drawings and claims, that changes and modifications can be made to the invention without departing from the true spirit and fair scope of the invention as defined in the following claims.

1. A multi-port tube for use in a heat exchanger, said tube comprising an extruded metal body made from an aluminum-based alloy consisting essentially of at least 0.70% and not more than 1.70% by weight of manganese, about 0.15-0.60% by weight of silicon, up to 0.05% by weight of titanium, up to 0.70% by weight of iron, about 0.006-0.70% by weight of copper and, up to 0.20% by weight of zinc, up to 0.30% magnesium and the balance aluminum, said aluminum tube in a brazed condition will have a higher yield strength, tensile strength, burst strength and elongation.

2. The multi-port tube in claim 1 wherein said body is subjected to successive cold working to a level wherein said thickness of the body is limited to five (5) percent reduction to retain small metallurgical grains in the body.

3. A process for improving the metallurgical strength of a multiport tube for use in a heat exchanger, limited cold working of said tube to create small metallurgical grains in the tube said tube comprising an extruded metal body made mainly from aluminum, and an alloy as follows and in the following percentages:
minimum 0.20% Si
minimum 0.50% Fe
minimum 0.05% Cu
minimum 1.00% Mn
